(19) United States
(12) Patent Application Publication
(10) Pub. No.: US 2017/0351747 A1
(43) Pub. Date: Dec. 7, 2017

(54) DATA ANALYSIS SYSTEM, DATA ANALYSIS METHOD, AND DATA ANALYSIS PROGRAM

(71) Applicant: FRONTEO, Inc., Tokyo (JP)

(72) Inventors: Masahiro Morimoto, Tokyo (JP); Hideki Takeda, Tokyo (JP); Takanori Takeda, Tokyo (JP)

(21) Appl. No.: 15/521,184

(22) PCT Filed: Oct. 23, 2014
(86) PCT No.: PCT/JP2014/078248

§ 371 Date: Apr. 21, 2017

(51) Int. Cl. G06F 17/30

(52) U.S. Cl. CPC G06F 17/30601

(57) ABSTRACT

The present invention is a data analysis system provided with: a classification information reception unit which receives classification information indicating a classification of data from a user via a predetermined input device; a data classification unit which associates the classification information with data to be classified included in a group of data, thereby classifying the data to be classified; an unclassified data evaluation unit which evaluates the relation between the classification information and unclassified data included in the group of data on the basis of the classification results; a tendency data selection unit which selects unclassified data matching the classification tendency of the user from the group of data in accordance with the evaluation results, said selected unclassified data being designated as tendency data; and a user presentation unit which, via a predetermined output device, presents the user with other users associated with the tendency data.

### TECHNICAL FIELD

The present invention relates to a data analysis system for analyzing data or the like.

### BACKGROUND ART

In recent years, a service enabling users to build a relation according to a purpose (e.g., social network service or the like) is drawing an attention. In such a service, it is important to appropriately match users with each other. Accordingly, a technology relating to matching has been developed widely.

For example, Patent Literature 1 discloses a game player matching system capable of allowing a general player having a short playing period to have a chance to fight with a specific player. Further, Patent Literature 2 discloses a matching system supporting selection of a matching range by participating players.

### CITATION LIST

### Patent Literature

Patent Literature 1: Japanese Patent Laid-Open No. 2014-176401

Patent Literature 2: Japanese Patent Laid-Open No. 2013-085819

### SUMMARY OF INVENTION

### Technical Problem

Generally, the amount of content included in the service and the number of users using the service are enormous. Therefore, with the conventional art, it is difficult to process the enormous data and identify desired data. For example, it is almost impossible for each user to find another user having a common taste.

The present invention has been made in view of the problem described above. An object thereof is to provide a data analysis system and the like, capable of identifying another potential user who has a high possibility of having common attributes with a user, and presenting it to the user.

### Solution to Problem

In order to solve the problem, a data analysis system, according to an aspect of the present invention, includes a classification information receiving unit that receives classification information indicating classification of data from a user via a predetermined input device; a data classification unit that associates the classification information with data to be classified included in a data group to thereby classify the data to be classified; an unclassified data evaluation unit that evaluates relevance between unclassified data included in the data group and the classification information, based on classification results provided by the data classification unit; a tendency data selection unit that selects, from the data group, unclassified data matching the classification tendency of the user as tendency data, according to an evaluation result provided by the unclassified data evaluation unit; and a user presentation unit that presents, to the user, another user related to the tendency data via a predetermined output device.

Further, the data analysis system according to an aspect of the present invention further includes an element extraction unit that extracts a data element from the data to be classified based on the classification information, and an element evaluation unit that evaluates the data element according to predetermined criteria, for example. The unclassified data evaluation unit can use the data element evaluated by the element evaluation unit as one of the classification results to thereby evaluate the relevance.

Further, in the data analysis system according to an aspect of the present invention, the element evaluation unit can use trans-information representing a dependency relationship between the data element and the classification information associated with the data to be classified including the data element, as one of the predetermined criteria, to thereby evaluate the data element, for example.

Further, the data analysis system according to an aspect of the present invention may further include an evaluation storage unit that stores an evaluation result provided by the element evaluation unit in a predetermined storage device, for example.

Further, in the data analysis system according to an aspect of the present invention, the unclassified data is data including at least an evaluation by a user with respect to an event, for example, and the data analysis system further includes an emotion extraction unit that extracts, from the unclassified data, emotion of the user who generated the unclassified data, with respect to the event caused based on the evaluation; and the tendency data selection unit can select the tendency data further according to an extraction result provided by the emotion extraction unit.

Further, the data analysis system according to an aspect of the present invention further includes an emotion storage unit that stores, in a predetermined storage device, a data element included in the unclassified data and an emotion evaluation with respect to the data element in association with each other, for example. The emotion extraction unit can evaluate the unclassified data with use of the emotion evaluation associated with the data element to thereby extract the emotion from the unclassified data.

Further, the data analysis system according to an aspect of the present invention may further include an invitation information receiving unit that receives, from the user via the predetermined input device, invitation information that urges the other user to belong to a community to which the user belongs, and a belonging information generation unit that, when the other user accepts the invitation, generates belonging information to allow the other user to belong to the community, for example.

Further, in the data analysis system according to an aspect of the present invention, the unclassified data evaluation unit can calculate a score indicating the strength of a connection between the unclassified data and the classification information based on the classification results to thereby evaluate the relationship, for example.

Further, in the data analysis system according to an aspect of the present invention, the unclassified data evaluation unit can calculate the score based on a correlation between a first data element and a second data element included in the unclassified data, for example.

Further, in the data analysis system according to an aspect of the present invention, the unclassified data includes at least data relating to text, for example, and the unclassified data evaluation unit can evaluate relevance between a sentence included in the text and the classification information based on the classification results, and based on the evaluation result, evaluate the relevance between the unclassified data and the classification information.

Further, in the data analysis system according to an aspect of the present invention, the classification information may be information indicating classification of whether or not to match the taste of the user, for example.

Further, in the data analysis system according to an aspect of the present invention, the data group may include a web page, for example, and the data, the data to be classified, and/or the unclassified data may include data showing text, an image, voice, or a moving image included in the web page or a combination thereof, for example.

Further, in the data analysis system according to an aspect of the present invention, the web page may be a page that provides a social network service, for example, and the data showing text, an image, voice, or a moving image or a combination thereof may be data posted by a user who uses the social network service, for example.

In order to solve the above-described problem, a data analysis method, according to an aspect of the present invention, includes a classification information receiving step of receiving classification information indicating classification of data from a user via a predetermined input device; a data classifying step of associating the classification information with data to be classified included in a data group thereby classifying the data to be classified; an unclassified data evaluating step of evaluating the relevance between unclassified data included in the data group and the classification information, based on a classification result provided in the data classifying step; a tendency data selecting step of selecting, from the data group, unclassified data matching the classification tendency of the user as tendency data, according to an evaluation result provided in the unclassified data evaluating step; and a user presenting step of presenting, to the user, another user related to the tendency data via a predetermined output device.

In order to solve the above-described problem, a data analysis program, according to an aspect of the present invention, causes a computer to implement a classification information receiving function of receiving classification information indicating classification of data from a user via a predetermined input device; a data classifying function of associating the classification information with data to be classified included in a data group thereby classifying the data to be classified; an unclassified data evaluating function of evaluating the relevance between unclassified data included in the data group and the classification information, based on a classification result provided by the data classifying function; a tendency data selecting function of selecting, from the data group, unclassified data matching the classification tendency of the user as tendency data, according to an evaluation result provided by the unclassified data evaluating function; and a user presenting function of presenting, to the user, another user related to the tendency data via a predetermined output device.

### Advantageous Effect of Invention

A data analysis system, a data analysis method, and a data analysis program, according to an aspect of the present invention, is capable of receiving classification information indicating classification of data from a user, associating the classification information with data to be classified included in a data group thereby classifying the data to be classified, evaluating the relevance between unclassified data included in the data group and the classification information based on a classification result, selecting unclassified data matching the classification tendency of the user according to a result of the evaluation; and presenting another user related to the selected data (tendency data) to the user. Accordingly, the data analysis system and the like exhibit an advantageous effect of identifying another potential user who has a high possibility of having common attributes with the user, and present it to the user.

### BRIEF DESCRIPTION OF DRAWINGS

FIG. 1 is a block diagram illustrating an exemplary configuration of main part of a data analysis system according to an embodiment of the present invention.

FIG. 2 a schematic diagram illustrating a procedure of processing performed by the data analysis system.

FIG. 3 is a schematic diagram illustrating a result of processing performed by the data analysis system.

FIG. 4 is a flowchart illustrating an example of processing performed in the data analysis system.

### DESCRIPTION OF EMBODIMENT

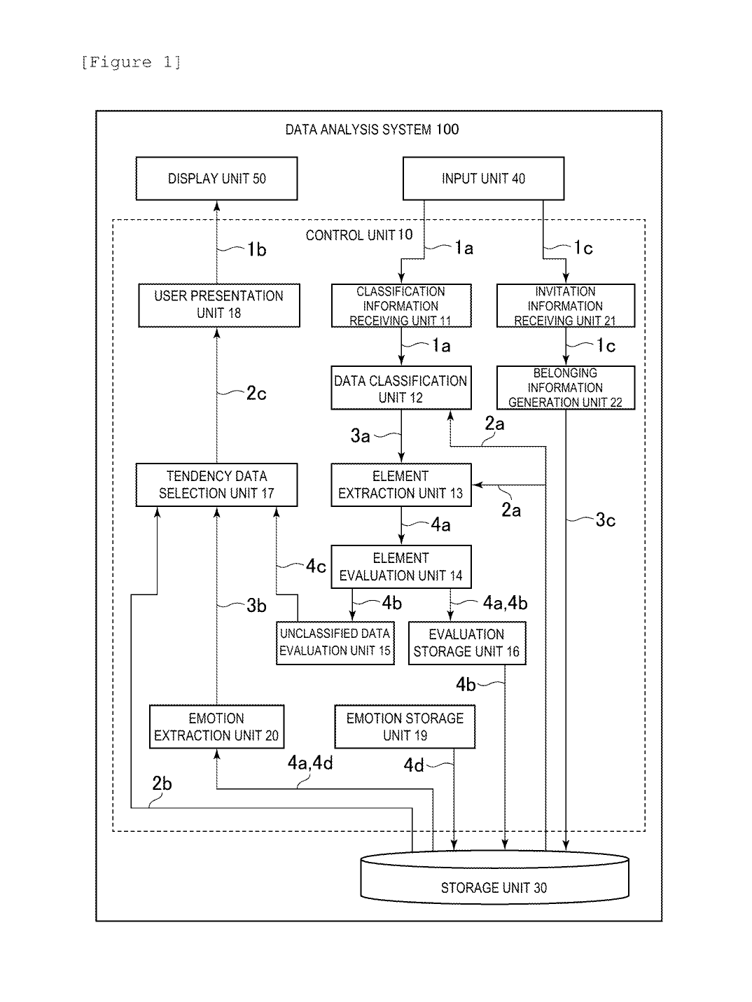

An embodiment of the present invention will be described based on FIGS. 1 to 4.

### [Overview of Data Analysis System 100]

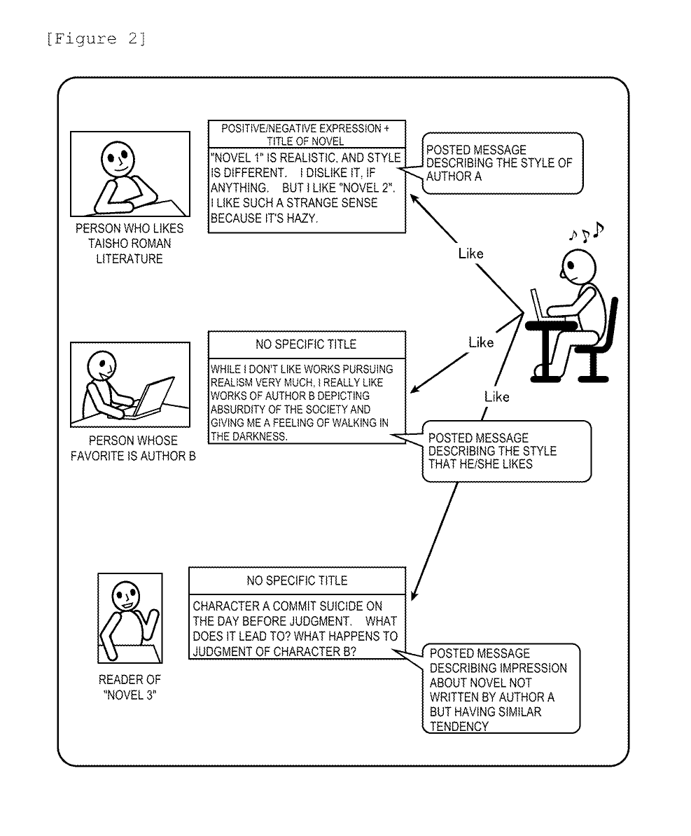

FIG. 2 is a schematic diagram illustrating a procedure of processing performed by a data analysis system 100. As illustrated in FIG. 2, a procedure of the processing will be outlined using an example that each user posts a review (data) of a novel to a social network service (hereinafter abbreviated to be “SNS”) as a data group.

A user gives classification information 1a (press “Like” button, for example) indicating classification of whether or not it matches the taste of the user with respect to a review (data to be classified 2a) matching the own taste among the reviews posted by other users, to thereby be able to classify reviews into “reviews matching the taste” and “reviews not matching the taste”. Based on results of the classification, the data analysis system 100 evaluates the relationship between other reviews (unclassified data 2b) to which the classification information 1a has not been given yet and the classification information 1a (for example, calculates a score indicating high or low of the relationship).

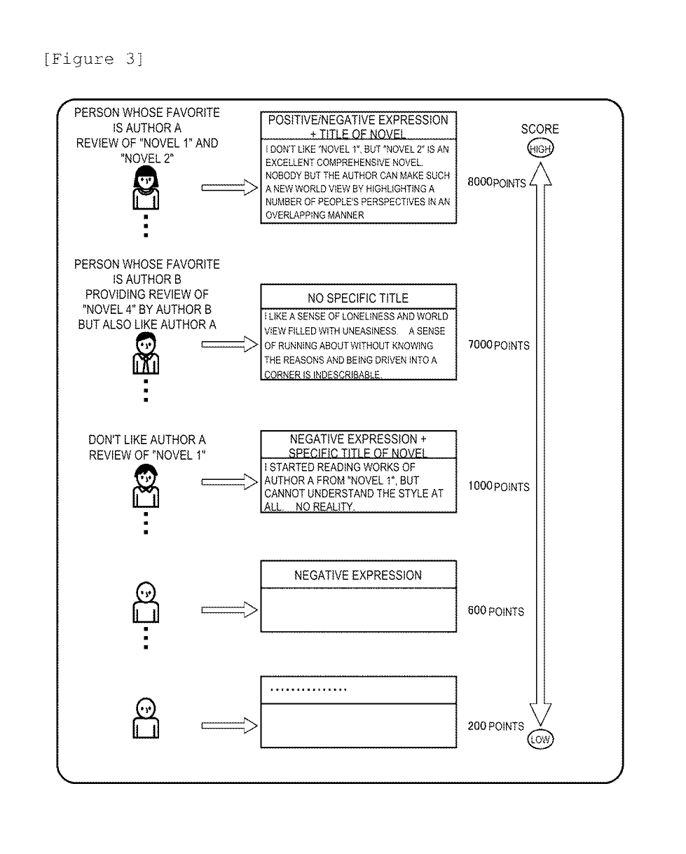

FIG. 3 is a schematic diagram illustrating a result of processing performed by the data analysis system 100. As illustrated in FIG. 3, the data analysis system 100 selects and extracts another review matching the classification tendency of the user from SNS according to the evaluation result, and puts another user who posted the selected review in a list. This means that the data analysis system 100 analyzes an enormous number of reviews posted to the SNS, and captures the meaning expressed in the reviews, to thereby extract a review similar to the review to which the user has given the classification information 1a (review having a high score), and identify another user who posted the similar review.

In this way, the data analysis system 100 analyzes any data (text, image, voice, moving image, and the like) included in a data group (e.g., web page such as SNS) to thereby be able to identify another potential user who has a high possibility of having common attributes (taste, interest, values, hobby, occupation, career, and the like) with the user, and present it to the user.

### [Configuration of Data Analysis System 100]

FIG. 1 is a block diagram illustrating an exemplary configuration of the main part of the data analysis system 100. The data analysis system 100 is an information processing system including at least one information processing device (for example, a computer such as a personal computer, a server device, or a main frame) capable of executing a data analysis program including a plurality of processes described below.

In the present embodiment, description will be given on an example in which the data analysis system 100 is embodied by one information processing device (computer). However, the system may be one including, for example, a plurality of information processing devices that execute a plurality of processes, described below, in a distributive manner arbitrarily. In particular, the data analysis system 100 can be preferably embodied by a multifunction device (e.g., computer or the like) having a display (display unit), an input device, a memory, and one or more processors capable of executing one or more programs stored in the memory.

As illustrated in FIG. 1, the data analysis system 100 includes a control unit 10 (a classification information receiving unit 11, a data classification unit 12, an element extraction unit 13, an element evaluation unit 14, an unclassified data evaluation unit 15, an evaluation storage unit 16, a tendency data selection unit 17, a user presentation unit 18, an emotion storage unit 19, an emotion extraction unit 20, an invitation information receiving unit 21, and a belonging information generation unit 22), a storage unit 30, an input unit 40, and a display unit 50.

The control unit 10 collectively controls various functions held by the data analysis system 100. The control unit 10 includes the classification information receiving unit 11, the data classification unit 12, the element extraction unit 13, the element evaluation unit 14, the unclassified data evaluation unit 15, the evaluation storage unit 16, the tendency data selection unit 17, the user presentation unit 18, the emotion storage unit 19, the emotion extraction unit 20, the invitation information receiving unit 21, and the belonging information generation unit 22.

The classification information receiving unit 11 receives classification information 1a indicating classification of data 2 from a user via a predetermined input device (for example, input unit 40). That is, the classification information receiving unit 11 acquires the classification information 1a from the input unit 40, and outputs the acquired classification information 1a to the data classification unit 12. In the below description, the data to be classified 2a and unclassified data 2b are simply referred to as “data 2” collectively.

Here, the classification information 1a is information of classification indicating whether or not it matches the user's taste, for example. In particular, in the case where the data 2 is data showing text, an image, voice, or a moving image or a combination thereof posted by a user using SNS, the classification information 1a may be information indicating whether or not it shows an intension of “like” (matching the user's taste) to the data 2. It should be noted that the classification information 1a may not be a binary flag of “whether or not it matches the user's taste” but may be information classifying the level of taste in multiple stages (multi-value flag) including “match”, “somewhat match”, “not somewhat match”, and “not match”, for example.

The data classification unit 12 associates the classification information 1a with the data to be classified 2a included in a data group to classify the data to be classified 2a. In this example, the data group may be a web page providing SNS, for example. Further, the data to be classified 2a may be data showing text, an image, voice, or a moving image included in the web page or a combination thereof, for example. The data classification unit 12 outputs classification results 3a in which the data to be classified 2a and the classification information 1a are associated with each other, to the element extraction unit 13.

The element extraction unit 13 extracts a data element 4a from the data to be classified 2a based on the classification information 1a. In this example, the data element 4a may be a keyword (e.g., morpheme) included in the text, a partial image included as part of an image, partial voice constituting part of the voice, a frame image constituting a moving image, or the like. The element extraction unit 13 outputs the data element 4a, extracted from the data to be classified 2a, to the element evaluation unit 14.

The element evaluation unit 14 evaluates the data element 4a in accordance with predetermined criteria. The element evaluation unit 14 is able to evaluate the data element 4a by using, as one of the predetermined criteria, trans-information representing the dependency relationship between the data element 4a and the classification information 1a associated with the data to be classified 2a including the data element 4a, for example. In the case where the data 2a is text included in a web page and the element extraction unit 13 extracts a keyword included in the text from the text, for example, the element evaluation unit 14 evaluates each keyword by calculating the weight of the keyword with use of the trans-information. The element evaluation unit 14 outputs the result of the evaluation (evaluation result 4b) to the unclassified data evaluation unit 15 and the evaluation storage unit 16.

The unclassified data evaluation unit 15 evaluates the relevance between the unclassified data 2b included in the data group and the classification information 1a, based on the classification results 3a provided by the data classification unit 12. For example, the unclassified data evaluation unit 15 is able to evaluate the relevance by using the data element 4a, evaluated by the element evaluation unit 14, as one of the classification results 3a.

Further, the unclassified data evaluation unit 15 calculates a score indicating the strength of a connection between the unclassified data 2b and the classification information 1a (for example, scaling is set to take a value ranging from 0 to 10000, indicating that the connection is stronger as the value is larger) based on the classification results 3a to thereby evaluate the relationship between the two.

For example, in the case where the unclassified data 2b is text included in a web page, the unclassified data evaluation unit 15 first generates a keyword vector indicating whether or not a predetermined keyword is included in the document. The keyword vector is, for example, a vector (bag of words) in which each element of the keyword vector takes a value of “0” or “1”, whereby it is indicated that whether or not a predetermined keyword corresponding to the element is included in the text. For example, when a keyword “price” is included in the text, the unclassified data evaluation unit 15 changes the element corresponding to the “price” of the keyword vector from “0” to “1”. Then, the unclassified data evaluation unit 15 calculates an inner product of the keyword vector (column vector) and a weight vector (column vector using a weight to each keyword as an element) as in the expression provided below, to thereby calculate a score S of the text.

S=w^{T}·S [Expression 1]

Here, s represents a keyword vector, and W represents a weight vector. It should be noted that T represents transposition of a matrix/vector (replacement of row and column).

Alternatively, the unclassified data evaluation unit 15 may calculate the score S according to the expression provided below.

$$S = \frac{{\sum }_{j = 1}^{N} {m}_{j} {w}_{j}^{2}}{{\sum }_{i = 1}^{N} {w}_{i}^{2}} \qquad [ Expression 2 ]$$

Here, m₃ represents appearance frequency of the j^{th} keyword, and wᵢ represents a weight of the i^{th} keyword. It should be noted that the unclassified data evaluation unit 15 may calculate the score based on the result of evaluating a first data element (first keyword) (weight of the first keyword) included in the unclassified data 2b and the result of evaluating a second data element (second keyword) (weight of the second keyword) included in the unclassified data 2b (that is, in consideration of co-occurrence of the keyword. Further, the unclassified data evaluation unit 15 may calculate a sentence score for each sentence included in the text, and calculate the score based on the sentence (the details of either case will be described below).

It should be noted that the unclassified data 2b may be data showing text, an image, voice, or a moving image included in the web page or a combination thereof, for example, similar to the data to be classified 2a. The unclassified data evaluation unit 15 outputs the result of evaluation (evaluation result 4c) to the tendency data selection unit 17.

The evaluation storage unit 16 stores the evaluation result 4b provided by the element evaluation unit 14, in a predetermined storage device (e.g., storage unit 30). For example, when the data to be classified 2a is text included in a web page and the element extraction unit 13 extracts a keyword included in the text from the text, the evaluation storage unit 16 associates the keyword extracted by the element extraction unit 13 with the weight of the keyword calculated by the element evaluation unit 14, and stores them in the storage unit 30.

The tendency data selection unit 17 selects, as tendency data 2c, the unclassified data 2b matching the classification tendency of the user, from the data group, according to the evaluation result 4c provided by the unclassified data evaluation unit 15. For example, when the unclassified data 2b is text posted by a user using SNS, and the score is calculated for each text as the evaluation result 4c by the unclassified data evaluation unit 15, the tendency data selection unit 17 selects (1) text having a score exceeding a predetermined threshold, or (2) a predetermined number of (e.g., 100) pieces of text having higher scores in the descending order, as the unclassified data 2b matching the classification tendency of the user, and outputs the unclassified data 2b to the user presentation unit 18 as the tendency data 2c. It should be noted that the tendency data selection unit 17 may select the entire unclassified data 2b as the tendency data 2c.

The user presentation unit 18 presents, to the user, other users related to the tendency data 2c via the display unit 50. For example, when the tendency data 2c input from the tendency data selection unit 17 is text posted by a user using SNS, the user presentation unit 18 outputs, to the display unit 50, display information 1b to allow the other users to be displayed on the display unit 50 so as to enable the users (the other uses) who posted the text to be listed.

The emotion storage unit 19 associates the data element 4a included in the unclassified data 2b and an emotion evaluation 4d corresponding to the data element 4a, and stores them in a predetermined storage device (e.g., the storage unit 30). For example, when the data 2 is text included in a web page, the emotion storage unit 19 searches the text for a predetermined keyword. When it is included, the emotion storage unit 19 extracts the keyword, and stores an emotion score, calculated in accordance with predetermined criteria, in the storage unit 30 as the emotion evaluation 4d in association with the keyword.

When the unclassified data 2b is data including at least an evaluation of the user with respect to a matter (indicating a wide variety of events to be used for evaluating the user), the emotion extraction unit 20 extracts emotion, with respect to the matter caused based on the evaluation, of the user who generated the unclassified data 2b, from the unclassified data 2b. Here, consideration will be given on the case where a user evaluates a matter of “reading a novel” to be “interesting”, and has a positive emotion that he/she “likes” (the style of the author and the like) based on the evaluation, and, as a review of the novel, posts text (unclassified data 2b) that “it was very interesting. I will recommend it to my family”, to a given web page (e.g., a page providing SNS) (see FIGS. 2 and 3).

First, the emotion extraction unit 20 determines whether or not a keyboard included in the text is stored in the storage unit 30 as the data element 4a. In the example described above, when the data element 4a of “interesting” is associated with a positive value (emotion evaluation 4d) of “+1.2” and is stored in advance in the storage unit 30 by the emotion storage unit 19, the emotion extraction unit 20 uses “+1.2” as an extraction result 3b of the text. Further, when the data element 4a of “recommend” is associated with a positive value (emotion evaluation 4d) of “+0.8” and is also stored in the storage unit 30 by the emotion storage unit 19, the emotion extraction unit 20 uses “+2.0 (=+1.2+0.8)” to be the extraction result 3b of the text. The emotion extraction unit 20 outputs the extraction result 3b to the tendency data selection unit 17.

When the extraction result 3b is input from the emotion extraction unit 20 to the tendency data selection unit 17, the tendency data selection unit 17 is able to select the tendency data 2c according to the evaluation result 4c by the unclassified data evaluation unit 15 and the extraction result 3b. For example, the tendency data selection unit 17 may select, as the tendency data 2c, unclassified data 2b having a score exceeding a predetermined threshold and from which positive emotion has been extracted (the extraction result 3b takes a positive value).

The invitation information receiving unit 21 receives, from a user, invitation information 1c that urges another user to belong to a community where the user belongs, via a predetermined input device (e.g., input unit 40). This means that the invitation information receiving unit 21 acquires the invitation information 1c from the input unit 40, and outputs the acquired invitation information 1c to the belonging information generation unit 22.

When the invitation for the other user to belong to the community is accepted by the other user, the belonging information generation unit 22 generates belonging information 3c to allow the other user to belong to the community, and stores the belonging information 3c in the storage unit 30, to thereby add or change the community to which the other user belongs.

The input unit (predetermined input device) 40 receives an input from the user. In the present embodiment, the input unit 40 may be a mouse, a keyboard, a touch panel, a microphone for voice input, or the like, for example. It should be noted that while FIG. 1 illustrates a configuration in which the data analysis system 100 includes the input unit 40, the input unit 40 may be any input device (e.g., input interface of a mobile terminal) communicably connected with the data analysis system 100.

The display unit (predetermined output device) 50 is a device displaying a processing result performed by the control unit 10 based on display information 1b input from the user presentation unit 18. In the present embodiment, the display unit 50 may be a liquid-crystal display. It should be noted that while FIG. 1 illustrates a configuration in which the data analysis system 100 includes the display unit 50, the display unit 50 may be any output device (e.g., display of a mobile terminal) communicably connected with the data analysis system 100.

The storage unit (predetermined storage device) 30 is a storage device configured of any recording medium such as a hard disk, a SSD (silicon state drive), a semiconductor memory, or a DVD, and stores a data analysis program capable of controlling the data analysis system 100 and arbitrary information used by the data analysis system 100. It should be noted that while FIG. 1 illustrates a configuration in which the data analysis system 100 includes the storage unit 30, the storage unit 30 may be any storage device communicably connected with the data analysis system 100.

### [Processing Performed by Data Analysis System 100]

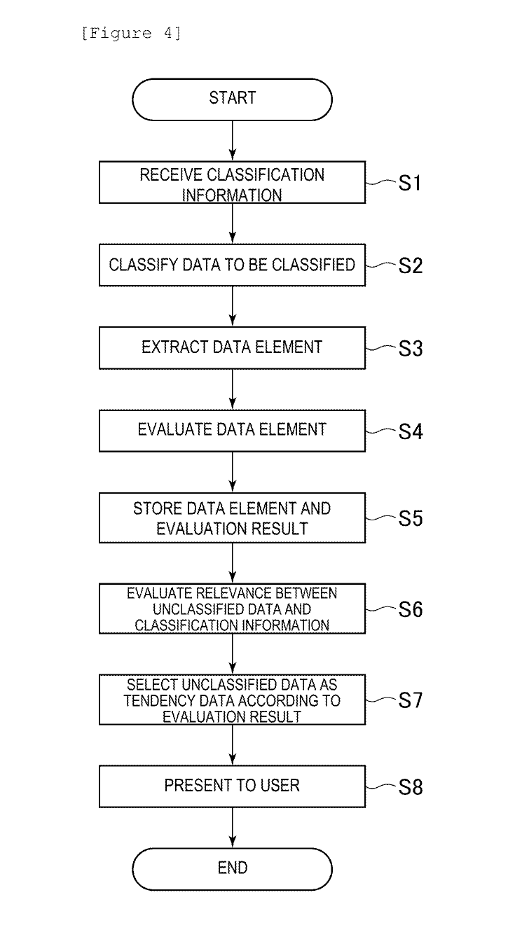

FIG. 4 is a flowchart illustrating an example of processing performed in the data analysis system 100. In the below description, “- step” in parentheses represents each step included in a data analysis method.

First, the classification information receiving unit 11 receives the classification information 1a indicating classification of data, from a user via a predetermined input device (e.g., input unit 40) (step 1, hereinafter “step” is abbreviated to “S”, classification information receiving step). Next, the data classification unit 12 associates the classification information 1a with data to be classified 2a (e.g., text described in a web page or the like) included in a data group (e.g., web page or the like) to thereby classify the data to be classified 2a (S2, data classification step). Then, based on the classification information 1a, the element extraction unit 13 extracts the data element 4a from the data to be classified 2a (S3), and the element evaluation unit 14 evaluates the data element 4a in accordance with predetermined criteria (e.g., trans-information) (S4). Then, the evaluation storage unit 16 stores the evaluation result 4b from the element evaluation unit 14, in a predetermined storage device (e.g., storage unit 30).

The unclassified data evaluation unit 15 evaluates the relevance between the unclassified data 2b included in the data group and the classification information 1a, based on the classification results 3a provided by the data classification unit 12 (S6, unclassified data evaluation step). Then, the tendency data selection unit 17 selects, from the data group, unclassified data 2b matching the classification tendency of the user according to the evaluation result 4c provided by the unclassified data evaluation unit 15, as the tendency data 2c (37, tendency data selection step). Finally, the user presentation unit 18 presents another user relating to the tendency data 2c, to the user via a predetermined output device (e.g., display unit 50) (S8, user presenting step).

It should be noted that the data analysis method described above may optionally include processing to be executed by each unit included in the control unit 10, in addition to the processing described with reference to FIG. 4.

### [Score Calculation Based on Co-Occurrence]

As described above, the unclassified data evaluation unit 15 is able to calculate a score based on the result of evaluating the first data element included in the unclassified data 2b and the result of evaluating the second data element included in the unclassified data 2b. For example, when the first key word appears in the text, the unclassified data evaluation unit 15 is able to calculate a score of the text in consideration of the appearance frequency of the second keyword in the text (that is, correlation between the first keyword and the second keyword, also called as co-occurrence).

In that case, the unclassified data evaluation unit 15 is able to calculate a score S in accordance with the expression provided below (rather than [Expression 1] described above) using a correlation matrix (co-occurrence matrix) C representing correlation (co-occurrence) between the first keyword and the second keyword.

S=w^{T}·(C·s) [Expression 3]

It should be noted that the correlation matrix C is optimized in advance using learning data set including a predetermined number of predetermined pieces of text. For example, in the case where a keyword “price” appears in text, with respect to the keyword, a value obtained by normalizing the number of appearances of another keyword to a value from 0 to 1 (namely, maximum likelihood estimation value) is stored in each element of the correlation matrix C (accordingly, the total sum of each column of the correlation matrix C takes 1).

As described above, as the data analysis system 100 is able to calculate a score in consideration of correlation between keywords, it is possible to identify another potential user who has a high possibility of having common attributes with a user, with higher accuracy.

### [Score Calculated Based on Sentence Score Calculated for Each Sentence]

As described above, the unclassified data evaluation unit 15 is able to calculate a sentence score for each sentence included in the text, and to calculate a score of the text based on the sentence score. In that case, the unclassified data evaluation unit 15 generates, for each sentence included in the text, a keyword vector indicating whether or not a predetermined keyword is included in the sentence. Then, the unclassified data evaluation unit 15 calculates a score for each text according to the expression provided below.

$$S = {w}^{T} \cdot TFnorm ( {\sum }_{i = 1}^{M} C \cdot {s}_{i} ) \qquad [ Expression 4 ]$$

Here, sₛ represents a keyword vector corresponding to the s^{th} sentence. It should be noted that co-occurrence is considered (correlation matrix C is used) when calculating the score according to [Expression 4] described above.

TFnorm can be calculated as shown in [Expression 5] provided below.

$$[ Expression 5 ]$$

$$TFnorm ( {\sum }_{s}^{N} C \cdot {s}_{s} ) = {( 1 + \frac{{\sum }_{s}^{N} {\sum }_{j \neq 1}^{n} {c}_{1 j} {s}_{js}}{{TF}_{1}} , 1 + \frac{{\sum }_{s}^{N} {\sum }_{j \neq 2}^{n} {c}_{2 j} {s}_{js}}{{TF}_{2}} , … , 1 + \frac{{\sum }_{s}^{N} {\sum }_{j \neq n}^{n} {c}_{nj} {s}_{js}}{{TF}_{n}} )}^{T}$$

Here, in [Expression 5] described above, TFᵢ represents appearance frequency (term frequency) of the i^{th} keyword, sⱼᵢ represents the j^{th} element of the i^{th} keyword vector, and cⱼᵢ represents an element of the j^{th} row and the i^{th} column of the correlation matrix C.

When aggregating [Expression 4] and [Expression 5] described above, the unclassified data evaluation unit 15 calculates the score for each text by calculating [Expression 6] provided below.

$$S = {\sum }_{i = 1}^{n} \{ {w}_{i} ( 1 + \frac{{\sum }_{s}^{N} {\sum }_{j \neq n}^{n} {c}_{ij} {s}_{js}}{{TF}_{i}} ) \} \qquad [ Expression 6 ]$$

Here, in [Expression 6] described above, wᵢ is the i^{th} element of the weight vector w.

As described above, the data analysis system 100 is able to calculate a score while correctly reflecting the meaning of the sentence. Accordingly, it is possible to identify another potential user who has a high possibility of having common attributes with a user, with higher accuracy.

### [Setting of Threshold]

As described above, the data analysis system 100 evaluates the data element 4a included in the unclassified data 2b according to a predetermined reference, based on the classification information 1a indicating classification of whether or not it matches the user's taste. Then, the data analysis system 100 calculates a score indicating the strength of the connection between the unclassified data 2b and the classification information 1a based on the evaluation result 4b, and is able to specify, as a matching threshold, a minimum score that can exceed a target value (target matching rate) set to a matching rate (ratio of the tendency data 2c selected as “matching the user's taste” to the data group).

This means that the data analysis system 100 is able to set the matching threshold based on the classification information 1a (result of determination by a human with respect to past data) given by a user, and select only the unclassified data 2b having a score exceeding the matching threshold as data having a high possibility of matching the user's taste (tendency data 2c), and present another user related to the tendency data 2c to the user. In other words, the data analysis system 100 analyzes current data based on the result of analyzing past data to thereby sort the unclassified data 2b. Thereby, the data analysis system 100 is able to analyze the user's taste in real time (analysis target data is not necessarily provided in advance), for example.

More specifically, in the case where scores are calculated for respective pieces of data to be classified 2a to which the classification information 1a is given, the data analysis system 100 changes the order of the scores into a descending order. Then, the data analysis system 100 scans the classification information 1a given to the data to be classified 2a in the order from the data to be classified 2a having the highest score (the score rank is the first), and sequentially calculates a ratio of the number of pieces of data to which the classification information 1a of “matching the taste” is given, to the number of pieces of data to which scanning has been completed at the current point of time (matching rate).

For example, in the case where the number of pieces of data to be classified 2a to which the classification information 1a is given is 100, it is assumed that when scanning of units of data having scores ranking from the 1^{st} to the 20^{th} has been completed, the number of units of data to which the classification information 1a of “matching the taste” is given is 18. In that case, the data analysis system 100 calculates the matching rate to be 0.9 (18/20). Further, when scanning for units of data having scores ranking from the 1^{st} to the 40^{th} has been completed, if the number of units of data to which classification information 1a of “matching the taste” is given is 35, the data analysis system 100 calculates the matching rate to be 0.875 (35/40).

The data analysis system 100 calculates matching rates regarding the entire data to be classified 2a, and specifies a minimum score capable of exceeding a target matching rate. Specifically, the data analysis system 100 scans the matching rates calculated with respect to units of the data to be classified 2a sequentially from the data to be classified 2a having a smallest score (score ranking the 100^{th}), and when the matching rate exceeds the target matching rate, specifies the score corresponding such a matching rate to be the smallest score (matching threshold) in which the target matching rate can be maintained.

Then, the data analysis system 100 determines whether or not the score calculated with respect to the unclassified data 2b, not having been determined whether or not it matches the user's taste, exceeds the matching threshold. The data analysis system 100 is able to select the unclassified data 2b, determined that it exceeds, to be the tendency data 2c. Thereby, the data analysis system 100 is able to analyze the user's taste in real time.

[Example of Application to a Data Group Other than SNS]

In order to allow the description to be easily understandable, an example in which the data analysis system 100 analyzes data included in SNS (text posted by another user using the SNS) has been described mainly. However, the data analysis system 100 is able to analyze data included in a data group other than SNS. For example, the data group may be a document group collected at the preparatory phase of discovery in a civil action in the United States.

In that case, the data analysis system 100 receives, as the classification information 1a, a discrimination sign (tag) that is an identifier, each given by a user (reviewer), to be used for classifying documents included in the document group (document group to be sorted), and associates the classification information 1a with the documents (data to be classified) included in the document group, to thereby classify the documents.

Then, the data analysis system 100 evaluates the relevance between another document (unclassified data) included in the document group and the classification information 1a based on the classification result (by calculating a score, for example), and selects and extracts a document matching the classification tendency of the reviewer according to the evaluation result, as the tendency data 2c. Finally, the data analysis system 100 displays persons related to the tendency data 2c (other users, for example, persons concerned in the action (custodians)) in a list. Thereby, the data analysis system 100 is able to reduce the burden on the reviewer who sorts the documents collected in the preparatory phase of the discovery.

[Example of Application to Data Other than Document]

In order to simplify the description, an example that the data analysis system 100 analyzes text has been given mainly. However, the data analysis system 100 is able to analyze data other than text. For example, in the case where the data analysis system 100 analyzes voice, the data analysis system 100 may (1) recognize the voice to thereby convert the content of the dialogue included in the voice into characters (text) and analyze the text, or (2) directly analyze the voice data.

In the case of (1) above, the data analysis system 100 converts voice into text with use of any voice recognition algorithm (e.g., recognition method using a hidden Markov model, or the like), and performs the same processing as that described above on the text. Thereby, the data analysis system 100 is able to analyze the voice.

In the case of (2) above, the data analysis system 100 extracts partial voice (data element) included in the voice. For example, when the voice of “adjusting the price” is obtained, the data analysis system 100 extracts partial voice of “price” and “adjusting” from the voice, and based on the result of evaluating the partial voice, the data analysis system 100 is able to evaluate the relevance between the unclassified voice (unclassified data 2b) and the classification information 1a. In this case, the data analysis system 100 able to classify the voice by using a classification algorithm of time series data (e.g., hidden Markov model, Kalman filter, neutral network, or the like). Thereby, the data analysis system 100 is able to analyze the voice.

Meanwhile, the data analysis system 100 is also able to analyze video (moving image). In that case, the data analysis system 100 extracts a frame image included in the video, and is able to specify a person included in the frame image by using an arbitrary face recognition technique. Further, the data analysis system 100 is able to extract motion of the person from partial video included in the video (video including part of the entire frame images included in the video) by using an arbitrary motion recognition technique (for example, it may be one applied with a pattern matching technique). Then, the data analysis system 100 is able to evaluate the relevance between unclassified video (unclassified data 2b) and the classification information 1a, based on the person and/or motion. Thereby, the data analysis system 100 is able to analyze the video.

### [Example of Implementation by Software]

A control block (particularly, the control unit 10) of the data analysis system 100 may be implemented by a logical circuit (hardware) formed on an integrated circuit (IC chip) or the like, or implemented by software by using a CPU (Central Processing Unit). In the latter case, the data analysis system 100 includes a CPU that executes instructions of a data analysis program that is software that implements respective functions, a ROM (Read Only Memory) or a storage device (these are referred to as “record media”) on which the data analysis program and various types of data are recorded in a readable manner by a computer (or CPU), a RAM (Random Access Memory) that develops the data analysis program, and the like. Then, the computer (or CPU) reads the data analysis program from the record medium and executes it, whereby the object of the present invention is achieved. As the record medium, a “non-transitory tangible medium” such as a tape, a disk, a card, a semiconductor memory, or a programmable logical circuit, may be used, for example. Further, the data analysis program may be provided to the computer via any transmission medium (communication network, broadcast wave, or the like) capable of transmitting the data analysis program. The present invention may be implemented in the form of a data signal embedded in a carrier wave, in which the data analysis program is embodied by electronical transmission.

Specifically, a data analysis program according to an embodiment of the present invention causes a computer to implement a classification information receiving function, a data classifying function, an unclassified data evaluating function, a tendency data selecting function, and a user presentation function. The classification information receiving function, the data classifying function, the unclassified data evaluating function, the tendency data selecting function, and the user presentation function can be implemented by the classification information receiving unit 11, the data classification unit 12, the unclassified data evaluation unit 15, the tendency data selection unit 17, and the user presentation unit 18, respectively. The details are as described above.

It should be noted that the data analysis program may be implemented by using a script language such as Python, ActionScript, or JavaScript (registered trademark), an object-oriented programming language such as Objective-C or Java (registered trademark), or a markup language such as HTML5, for example. Further, a distributed data analysis system including an information processing device having respective units that implement the respective functions achieved by the data analysis program and a server device having respective units that implement the remaining functions other than the aforementioned functions also falls under the category of the present invention.

[Configuration that Server Device Provides Partial or Whole Functions]

It also possible to have a configuration in which part or whole of a data analysis program capable of providing a function of analyzing data is executed by a server device as the data analysis system 100, and a result of the executed processing is returned to an arbitrary information processing terminal. This means that the data analysis system of the present invention is able to function as a server device communicably connected with a user terminal over a network.

For example, a predetermined input device is provided, and the classification information receiving unit 11 is implemented in a user terminal (e.g., smartphone, personal computer, or the like) used by a user, and the classification information 1a received by the computer is transmitted over the network to the server device in which the data classification unit 12, the element extraction unit 13, the element evaluation unit 14, the unclassified data evaluation unit 15, the evaluation storage unit 16, the tendency data selection unit 17, the user presentation unit 18, the emotion storage unit 19, the emotion extraction unit 20, the invitation information receiving unit 21, and the belonging information generation unit 22 are implemented. Then, the server device receives the classification information 1a, executes the respective types of processing described above, and transmits the execution result (display information 1b) to the user terminal.

Thereby, as a system including the server device and the user terminal, the data analysis system of the present invention is implemented.

### [Supplementary Notes]

The present invention is not limited to the respective embodiments described above, and various changes can be made within the scope of the claims. Embodiments that can be obtained by appropriately combining technical means disclosed in different embodiments are also included in the technical scope of the present invention. Further, by combining technical means disclosed in the respective embodiments, it is possible to form a new technical feature.

It should be noted that the data analysis system according to the present invention may also be expressed as a data analysis system including a classification information receiving unit that receives classification information indicating classification of data from a user via a predetermined input device; a data classification unit that associates the classification information with data to be classified included in a data group to thereby classify the data to be classified; an unclassified data evaluation unit that evaluates the relevance between unclassified data included in the data group and the classification information, based on a classification result provided by the data classification unit; and a user presentation unit that identifies another user related to unclassified data matching the classification tendency of the user, according to an evaluation result provided by the unclassified data evaluation unit, and presents, to the user, the identified other user via a predetermined output device.

Further, a data analysis system according to the present invention may also be expressed as a data analysis system including an extraction unit that extracts a sorted document group including a predetermined number of documents from document information as a target of sorting by a user; a sorting sign receiving unit that receives a sorting sign that is an identifier to be used for classifying the document, the sorting sign being given to each document included in the sorted document group by the user; a database that stores a keyword selected based on the sorting sign from the document included in the sorted document group; and a score calculation unit that calculates a score evaluating the strength of a connection between the document included in the document information and the sorting sign, based on the keyword.

Further, a data analysis system according to the present invention may also be expressed as a data analysis system capable of extracting data related to a given matter from a number of units of data acquired from the surroundings of a vehicle, the system including a relationship evaluation unit that evaluates, in the case where undetermined data that has not yet been determined to be related to the given matter or not is newly acquired, a relationship between the undetermined data and the given matter based on determined data having been determined whether or not to be related to the given matter by the driver who drives the vehicle, and a data reporting unit that reports the undetermined data to the driver according to the relationship evaluated by the relationship evaluation unit.

### INDUSTRIAL APPLICABILITY

The present invention is widely applicable to any computer such as a personal computer, a server device, a workstation, or a main frame.

### REFERENCE SIGNS LIST

1a classification information
1c invitation information
2a data to be classified
2b unclassified data
2c tendency data
3a classification result
3c belonging information
4a data element
4b evaluation result
4c evaluation result
11 classification information receiving unit
12 data classification unit
13 element extraction unit
14 element evaluation unit
15 unclassified data evaluation unit
16 evaluation storage unit
17 tendency data selection unit
18 user presentation unit
19 emotion storage unit
20 emotion extraction unit
21 invitation information receiving unit
22 belonging information generation unit
30 storage unit (predetermined storage device)
40 input unit (predetermined input device)
50 display unit (predetermined output device)
100 data analysis system

1. A data analysis system comprising a controller for data analysis, the controller presenting other users having relevance with a user,
wherein the controller:
receives classification information for classifying data from a user via a predetermined input device;
associates the classification information with data to be classified included in a data group to thereby classify the data to be classified;
evaluates relevance between unclassified data included in the data group and the classification information, based on a result of the classification;
selects, from the data group, unclassified data having a tendency for the classification as a plurality of pieces of tendency data, according to a result of the evaluation; and
presents, to a device of the user, a plurality of other users related to the plurality of pieces of tendency data as a related user list.

2. The data analysis system according to claim 1,
wherein the controller:
extracts a data element from the data to be classified based on the classification information;
evaluates the data element according to predetermined criteria; and
evaluates the relevance based on the evaluation of the data element.

3. The data analysis system according to claim 2,
wherein the controller evaluates the data element according to a transmitted information amount based on a dependency relationship between the data element and the classification information associated with the data to be classified including the data element.

4. The data analysis system according to claim 2,
wherein the controller stores an evaluation result of the data element unit in a predetermined storage device.

5. The data analysis system according to claim 1,
wherein the controller:
extracts an emotional expression for an event included in the unclassified data from the unclassified data on the basis of evaluation of the event; and
selects the tendency data on the basis of an extraction result of the emotional expression and an evaluation result of the relevance.

6. The data analysis system according to claim 5,
wherein the controller associates a data element included in the unclassified data with an emotion evaluation with respect to the data element and extracts the emotional expression from the unclassified data on the basis of the emotion evaluation.

7. The data analysis system according to claim 1,
wherein the controller:
receives, from the user, invitation information that urges the other users to belong to a community to which the user belongs; and
transmits belonging information to the other users to allow the other users to belong to the community when obtaining approval information from the other users on the basis of the invitation information.

8. The data analysis system according to claim 1,
wherein the controller calculates a score indicating strength of a connection between the unclassified data and the classification information and evaluates the relevance on the basis of a result of the calculation.

9. The data analysis system according to claim 8,
wherein the controller calculates the score based on a correlation between a first data element and a second data element included in the unclassified data.

10. The data analysis system according to claim 1,
wherein the controller evaluates relevance between a sentence of text included in the unclassified data and the classification information and evaluates relevance between the unclassified data and the classification information based on the evaluation result.

11. The data analysis system according to claim 1,
wherein the controller classifies the data to be classified on the basis of taste of the user.

12. The data analysis system according to claim 1,
wherein data constituting the data group includes at least one of text, an image, voice, and a moving image included in a web page.

13. The data analysis system according to claim 12, wherein
the web page includes information for providing a social network service, and
at least one of the text, image, voice, and moving image is data posted by a user of the social network service.

14. A method for controlling a data analysis system equipped with a controller for data analysis, the controller presenting other users having relevance with a user,
wherein the controller executes:
a step of receiving classification information for classifying data from a user via a predetermined input device;
a step of associating the classification information with data to be classified included in a data group, thereby classifying the data to be classified;
a step of evaluating relevance between unclassified data included in the data group and the classification information, based on a result of the classification;
a step of selecting, from the data group, unclassified data having a tendency to be classified by the user as a plurality of piece of tendency data, according to a result of the evaluation; and
a step of presenting, to a device of the user, a plurality of other users related to the plurality of pieces of tendency data as a related user list.

15. A non-transitory storage medium storing a program for presenting other users having relevance with a user,
the program causing a computer to implement:
a function that receives classification information for classifying data from a user via a predetermined input device;
a function of associating that associates the classification information with data to be classified included in a data group, thereby classifying the data to be classified;
a function that evaluates relevance between unclassified data included in the data group and the classification information, based on a result of the classification;
a function that selects, from the data group, unclassified data having a tendency to be classified by the user as a plurality of piece of tendency data, according to a result of the evaluation; and
a function that presents, to a device of the user, a plurality of other users related to the plurality of pieces of tendency data as a related user list,
wherein the non-transitory storage medium is readable by the computer.
